(19) United States
(12) Patent Application Publication
(10) Pub. No.: US 2026/0361423 A1
(43) Pub. Date: Nov. 12, 2026

(54) COMMUNICATION METHOD AND SYSTEM FOR ELECTRONIC DEVICES

(71) Applicant: Elliptic Laboratories ASA, Oslo (NO)

(72) Inventor: Espen KLOVNING, Strømmen (NO)

(73) Assignee: Elliptic Laboratories ASA, Oslo (NO)

(21) Appl. No.: 19/125,126

(22) PCT Filed: Nov. 16, 2023
(86) PCT No.: PCT/NO2023/060095

§ 371 Date: Apr. 28, 2025

(30) Foreign Application Priority Data
Nov. 18, 2022 (NO) 20221245

(51) Int. Cl. H04B 11/00; H04R 1/20; H04W 76/10

(52) U.S. Cl. CPC H04B 11/00; H04R 1/20; H04W 76/10; H04R 2420/07

(57) ABSTRACT

The present invention relates to a method and corresponding system for establishing communication between two electronic devices. The method includes the steps of-transmitting from a first of said devices a first, acoustic signal in a predetermined frequency range for at least one predetermined time period, the acoustic signal including a recognizable code, the code including connecting information,—receiving at a second of said devices the acoustic signal and analyzing said code, where the analysis includes recognizing the at least one predetermined time period(s),—based on said code transmitting a second signal for establishing communication with the first device.

The present invention is related to a method and system for providing communication between electronic devices. Specifically, the communication includes the use of acoustic signals for establishing communication between two or more near-by electronic devices. This includes an electronic device that can use time-modulated acoustic signals or other coded acoustic signals to transmit an acoustic message (e.g. protocol message or coded message) with limited information, for example a coded version of at least one of its own network addresses to enable neighboring electronic devices to connect to the transmitting electronic device.

Many electronic devices such as mobile phones and laptops include acoustic transducers being capable of sending and receiving acoustic signals. The acoustic signals may be in the infrasonic range, the audible frequency range or in the ultrasonic range. If the acoustic signal is in the audible frequency range, the acoustic message can be heard by humans unless the frequencies used by the acoustic message and their amplitudes can be hidden in another audible signal (e.g. notification sound, music playback, voice commands from transmitting device, etc) being transmitted either by the electronic device or a nearby electronic device masking the audible acoustic message. In US2021/0037210 such a system is described where a device transmits an ultrasonic signal and a receiving device received and extracts the address of the transmitting device which in turn may be used to provide a WiFi connection or similar between the two. US2012/0214416 describes devices capable of establishing communication where one of them transmits an invitation signal in a transmitted acoustic signal and the other device is configured to accept the invitation and allow connection, and a similar solution is also disclosed in US2020/314654.

In US20190394567 a solution is using an acoustic signal to analyze the surroundings, where the acoustic signal may include codes. The transmitted codes are used to analyze the surroundings, and any communication with other units in the surroundings is performed transmitting packets using radio transmissions using electronic communication protocols.

One problem related to the prior art is that transmitting the acoustic message incurs some power consumption. While systems as discussed in US2021/0037210 are stationary and usually connected to a power source many devices rely on limited battery capacity and thus there is an object of the present invention to reduce the power consumption of the system and devices in the system. Another problem is that continuous signal transmission increases the general noise level and interference in an environment including several devices trying to communicate with acoustic messages and/or representing other systems using the same acoustic frequency range. It is an object of the present invention to provide solutions, including a method and system, aimed at solving these problems. This is achieved as stated in the accompanying claims.

The present invention thus relates to a communication that is established based on a first acoustic signal including a recognizable code for a time period and a second device that receives the acoustic signal with the code and analyzing it and the time period and use the code for establishing a communication with the first device. Thus the first device has an acoustic transmitter (such as a speaker) while the second has a receiver (such as a microphone)

The present invention may use a single acoustic signal (e.g. sine signal) or a plurality of acoustic signals (e. g multiple sines with different frequencies denoted F1, F2, F3, etc) to encode data using time-modulation and transfer the data to other electronic devices nearby in acoustic messages.

Several embodiments of the present invention may be considered. In some cases, the acoustic messages will include several pieces of information that will enable receiving electronic devices to connect to the transmitting electronic device using a preferred communication network (e.g. Bluetooth, Wifi, 5G, etc). The transmitted signal may also include additional information about the electronic device beyond its network address or the services that the electronic device is offering. It may include the SSID of the wireless network the transmitting electronic device is connected to and a monotonically increasing sequence number or a timestamp to make sure that even consecutive acoustic messages are different. It is also possible to use Forward Error Correction schemes (e.g. Reed-Solomon FEC) to be able to correct errors in the receive process in the second device. One example would be a protocol message embedded in an acoustic message that includes a challenge, a network type, the protocol and the corresponding port number that should be used to connect to the transmitting electronic device. The transmitted signal could in some embodiments include the network address of another electronic device which may or may not have the capability to transmit acoustic signals itself. The transmitting signal could in some embodiments include more than one network address and supplemental information about an electronic device. The transmitting signal could in some embodiments include the network address(es) and supplemental information about a set of electronic devices identified by their network addresses.

The basic principle of the invention is that the acoustic signal is only transmitted from a first electronic device for a specific time period (e.g. time-modulation or coded signal) or repeatedly with a specific rate (e.g. 2 Hz) allowing a second electronic device with an acoustic receiver to receive the said signal and through processing in software or hardware to detect the transmitted signal by demodulating or decoding the received signal. Since a demodulating second device can detect the exact transmit period of the acoustic signal transmitted by the first device, the first and second device can exchange information by sending a set of consecutive acoustic signals where information is encoded by using the time period of the transmitted acoustic signal. The first device may increase the data rate by transmitting data in parallel transmitting information using independent time periods at multiple acoustic frequencies simultaneously. If the first device is transmitting a coded signal using one of more sines or sine pulses (e.g. 100-200 ms), the second device can decode the signal by extracting the sines or sine pulses using signal processing or Deep Neural Networks trained for the decoding process. The number of unique codes depends on the number of different sine frequencies available for the coded communication between devices and the number of sine pulse frequencies used by the first device in the coded message. In a case with 20 different sine frequencies available and the first device using 3 different sine pulses in each message, the number of unique sine pulse triplets is 1140. The separation of the sines when using multiple sines may have to take Doppler-effects into account, e.g. as described in NO20221244, otherwise the separation when users are walking must be at least 150-200 Hz.

The specific time period used for modulating devices may be defined as a period where the signal exceeds a limit at one set of frequencies which may be detected by the second device at a distance. The signal may be repeated or continue at a lower volume and/or alternative frequencies. In addition, the second device may adjust the sensitivity or frequencies depending on reception, searching for signals at other frequencies and amplitudes.

The present invention will be described below with reference to the accompanying drawings, illustrating the invention by way of examples.

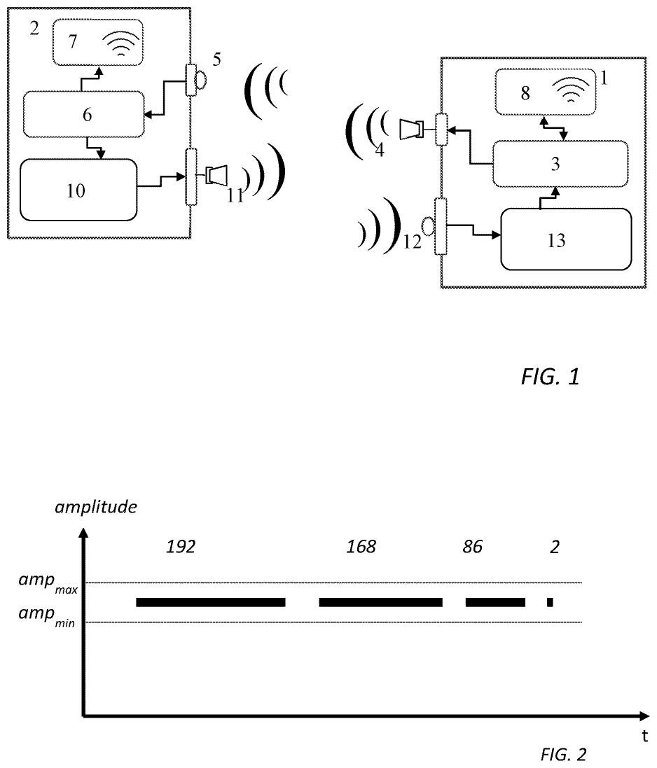

FIG. 1 illustrates the system according to the invention including a first and a second device.

FIG. 2 illustrates the process according to a first embodiment of the invention.

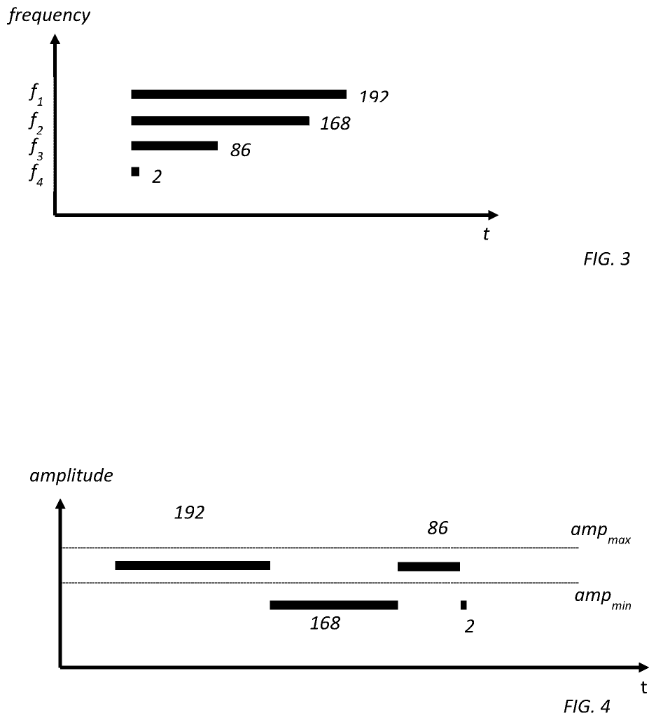

FIG. 3 illustrates the transmitted signal according to another embodiment of the invention using multiple frequencies.

FIG. 4 illustrates the transmitted signal according to yet another embodiment of the invention using a variable amplitude distinguishing the signal durations.

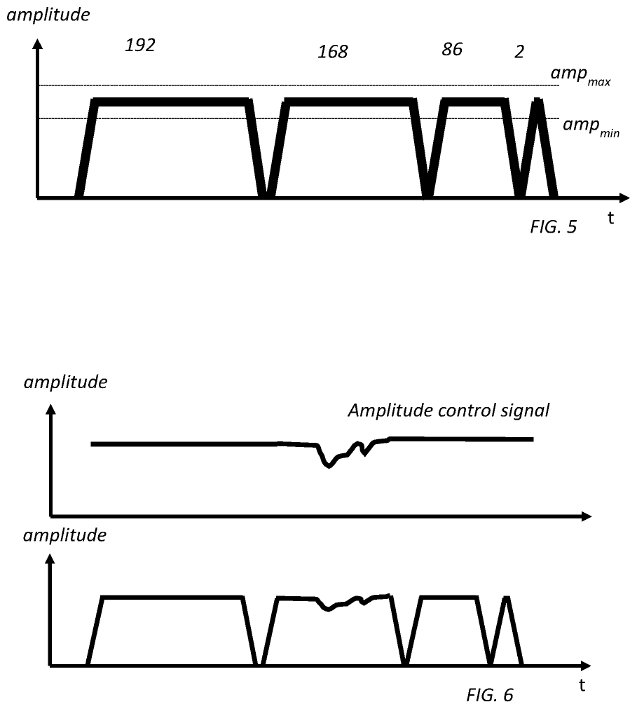

FIG. 5 illustrates the time sequence of the transmitted signal in the time domain.

FIG. 6 illustrates the compensation for variable signal strength.

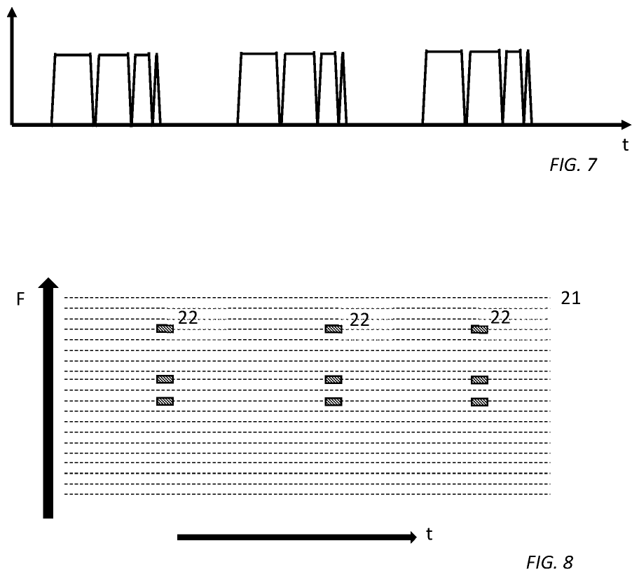

FIG. 7 illustrates a time sequence of the signal according to FIG. 5.

FIGS. 8,9 illustrates the use of several frequencies.

As illustrated in FIG. 1 the present invention involves at least one first device 1 and a second device 2. The first device 1 includes a first processor 3 generating a signal being transmitted to a speaker or similar transducer 4 being capable of transmitting an acoustic signal within a chosen frequency range, thus acting like an acoustic message where the acoustic signal includes a recognizable code or protocol message. As will be discussed below, the acoustic message includes information directly or indirectly for obtaining wireless communication, e.g. containing an internet protocol/IP address for WiFi connection.

The second device 2 includes a microphone 5 or similar transducer capable of receiving signals within the chosen acoustic frequency range and transmitting the received signal to a second processor 6. The second processor 6 is configured to analyze the received signal in order to find a code and, if applicable, forwarding the code to a communication unit 7 which is configured to transmit a WiFi signal requesting access to the first device address. Alternatively, the second device may request more information about the device through a lookup service using data communication (e.g. WIFI) or a local lookup from an updated device information database in the second device. The device information lookup could provide necessary information for the second device to initiate data communication (e.g. WIFI, Bluetooth) with the first device or another device in cases where the first device is acting as a proxy for the device the second device needs to communicate with. When receiving the signal in the WiFi-unit of the first device, a WiFi communication may be initiated.

As an alternative, the second device may respond by generating an acoustic response signal 10 and transmitting it through a speaker in the second device which may be received 12 by the first device, analyzed 13 and if applicable provide the extracted information to the first processor 3. This could be the case when the first device is requesting the IP address of the second device and the second device responds by transmitting the address using an acoustic signal. This might be necessary if the coded signal from the first device is not unique preventing the first device uniquely identified by the transmitted code. In that case second device could initiate an acoustic handshake with the first device using other predefined pseudo-random generated coded signals known by the intended first device and the corresponding second device or modulated signals. These handshake messages can use the same or a different frequency range than the previous messages between the devices. The coded messages may not identify the first device without a prolonged handshake process but the number of overlapping first devices will quickly be reduced by using this acoustic handshake process.

Yet another alternative is that the second device 2 transmits a request signal, either acoustically or using wireless communication to activate the first device to transmit the modulated or coded message.

In use, the first and second device may not be the only ones present in the vicinity. The area may include several first devices and other devices which may be chosen by user interfaces where the users of the different devices may allow initiation, by choosing the devices having the highest amplitude or by connecting to devices being recognized by the first or second device, e.g. as the communicated codes have been stored in the device. A user may choose a certain acoustic message or first device or the acoustic message may be set to give priority to certain devices.

The present invention is especially aimed at the acoustic message signal being transmitted form the first device including the code for establishing device communication using wireless communication such as WiFi or Bluetooth.

The acoustic message may be sent continuously or as time-separated messages with a fixed or variable message rate (e.g. “use 2 Hz message rate and send a new message every 500 ms”) within the specific time period. If the acoustic message is sent continuously, the beginning of the acoustic message needs to be identifiable. The acoustic message could also include a random shift (e.g. up to 30% of the time between two acoustic messages given the predefined rate) based on a pseudo-random number generator with a known seed known by both devices. One option is to start the acoustic message with a time-modulated time period that is identifiably larger than the largest number to be encoded. Another option is to change the amplitude value of the sine to a third level which is lower than the time-modulated time periods but significantly different from amplitude level between the time-modulated time periods. A third option is to include a fixed preamble or flag like what is used for link-layer protocols such as HDLC (i.e. Flag Sequence Field). A fourth option would be to change the frequency, the phase, the amplitude level or any combination of these changes in an identifiable pattern that could be detected by the second device either using signal processing or a neural network engine trained to detect the pattern transmitted by the first device.

In some scenarios, the first device will not send any unsolicited acoustic messages in order to save power and avoid transmitting acoustic signals without reason. In these scenarios, any second device that enters the space of the first device should instead send its own acoustic solicitation message to the first device to request an acoustic message with the required information. Once the first device receives, processes, decodes and interprets the solicitation, the first device will start sending the acoustic message with a high message rate. It may use a backoff mechanism where the message rate is reduced until a minimum message rate has been reached. Once a second device has extracted the information in the acoustic message, it can send a message to the first device over the communication network to let the first device know that the acoustic message was successfully received. The message from the second device may include data indicating to the first device that transmitting the acoustic message is either no longer required or that the acoustic message should only be sent X times more where X is a predefined configuration value or included in the message from the second device.

The first device or any other motion detection devices in the space may use motion detection such as inertia measuring units which may trigger distance measurements or estimates to the closest user in the space and use the information to decide when to transmit the acoustic messages. The distance measurements may be performed using acoustic signals, as discussed in NO20221247 without adding further encoding to the signal. Other activity measurements may also be used as a trigger, such as touch screen/sensor, light sensors or recognizing sounds. The first device may start sending acoustic messages once motion or activity is detected in the space or room where the first device is located as discussed in NO20221246 where propagations time and phase shift may be used to detect relative distance between two devices using acoustic signals including at least one acoustic transducer on one device and at least one transducer on the second device. If the orientation is measured one of the devices have two transducers either receiving or transmitting the acoustic signal. Once the motion detector is not detecting any motion anymore, transmission of the acoustic messages may be stopped. The acoustic messages may also be stopped if the distance exceeds a certain limit.

In some embodiments, more than one second device may be allowed to communicate with the first device. In these situations, the first device should keep sending acoustic messages for a preconfigured period either based on the number of messages or an absolute time. In some cases, the first device may use a backoff mechanism where the time between acoustic messages is doubled until it reached a maximum value. The first device may be configured to continue to transmit acoustic messages with this message rate to make sure that devices that show up later can still receive the acoustic message. The alternative is that newly arrived second devices send out an acoustic message themselves that request the first device to start a new sequence of transmitting acoustic messages.

The second device may measure the SNR and potentially the amplitude value of the acoustic signals while processing the acoustic message and include the information in the message sent to the first device or proxied device over the communication network. According to one embodiment the first device may use these values to change either the characteristics, such as the amplitude or frequencies of the acoustic signals or the transmit unit used for the time-modulation.

In one embodiment of the present invention illustrated in FIG. 2, the first device will transmit a coded version of an IPv4 network address using a single acoustic frequency. In this example, the network address of the first device is 192.168.86.2. In FIG. 2, the first device sends a sine signal with four identifiable time periods where the amplitude is within a predefined range for 192 samples in the first identifiable time period. In the second, third and fourth identifiable time periods, the signal will be within an acceptable amplitude for 168, 86 and 2 samples. In some scenarios, the second device will not be able to detect the number of samples in a time period to within a single sample. In situations where the second device for different reasons does not have the resolution to detect time periods to within a single sample, the first device could extend the transmit period identifying a number M by transmitting the signal for N*(M+1) samples where N is the size of a transmit unit. The reason for adding one transmit unit as an offset (i.e. M+1) is to be able to encode the number 0. If M is 0, the identifiable time period will be N samples. If M is 1, the identifiable time period will be N*2 samples. The second device must take the 0-offset into account when calculating the number M from the measured time period of the received signal. If the transmit unit is 2, the IP address would be transmitted in identifiable time periods of 386, 338, 174 and 6 samples. The second device would detect the identifiable time periods and divide the detected time periods with the transmit unit (i.e. N=2) and subtract the 0-offset (i.e. N=2) to get to the 192.168.86.2 IP address. The detection period of the IP address using a single sine frequency as discussed above with N=1 is 193+169+87+3=452 samples. At 48 kHz, the detection period with N=1 will be approximately 10 milliseconds

In another embodiment of the present invention, the first device will combine the time-modulation with the use of multiple frequencies to transmit the IP address using four sine signals simultaneously. The sine frequencies must be separated enough in frequency (Hz) to allow the second device to keep them apart to receive the data from each of them correctly at the same time. The sine frequencies will normally have to be separated by 100-300 Hz to handle the doppler effect of a user walking.

If the second device has sensors (e.g. gyroscope and accelerometer, hall-effect sensors or other sensors that provides rotational or linear speed) that can be used to measure the movement of the second device in either direction along the line between the first and second device, the second device could either adjust to the doppler-shifted version of the frequencies transmitted by the first device, e.g. as described in NO20221244. Another option is that the second device may ignore the acoustic message if the movement sensors indicate that the second device is moving more than a predefined amount. If so, the second will wait until it will no longer experience any issues related to the doppler-shift of the frequencies. With a transmit unit of N, the IP address 192.168.86.2 will be transmitted using the four different sine frequencies with time periods of N*(192+1), N*(168+1), N*(86+1) and N*(2+1) samples respectively. The detection period of the IP address using four sine frequencies simultaneously as discussed above is time period of the largest number transmitted. In this example, the detection period is the transmission time of the largest number N*(192+1)=N* 193 samples. At 48 kHz, the detection period will be approximately N*4 milliseconds.

In one embodiment of the present invention, the first device will transmit a coded version of an IPv4 network address using a single acoustic frequency. In this example, the network address of the first device is 192.168.86.2 which is 0xC0-0xA8-0x56-0x02 as hexadecimal numbers. If the first device transmits a sine signal with eight identifiable time periods where each time-modulated time period corresponds to every nibble in the hexadecimal representation of the IPv4 network address. The time-modulated time period of 0xC would be N*(0xC+1)=N*13. The rest of the time-modulated time periods would be N*1, N*11, N*9, N*6, N*7, N*1 and N*3. In total, the detection period would be N*38 samples.

Although the most common data unit in most embodiments is a 4-bit nibble, the first device may separate the acoustic message into a series of bits and transmit the acoustic message using only two different time-modulated time periods corresponding to the values 0 and 1.

The first device may listen for other sources transmitting with at least one overlapping or interfering frequency used by the first device. If so, it may delay transmission until the other sources stop transmitting. If the other sources continue to transmit an interfering acoustic signal, the first device may change the frequency of the sine or sines that experience unwanted interference to remove or reduce the effect of the interference from the other transmitting sources. The concept of frequency hopping to avoid interference is described in more detail in Norwegian patent application NO20220394. Since the first device may change one or more of the frequencies it is using for the time-modulation, the second device must be ready to handle reception of an unknown or predefined set of frequencies. Detecting multiple frequencies is possible with FFT processing. To make sure a specific frequency is used for an acoustic message, the message should include a preamble as discussed above to makes it clear that this is the beginning of an acoustic message. Since a first device may use multiple frequencies to transmit the acoustic message and all or some of them may have been transmitted with a non-standard frequency, the frequency number (e.g. F1, F2, F3, F4, etc) that is needed to make sure the decoding of the acoustic message is correct must be included in the acoustic message.

In another embodiment of the present invention illustrated in FIG. 3, the first device may combine the time-modulation with the use of multiple frequencies denoted f₁, f₂, f₃, f₄) to encode data using time-modulation and transfer the data to other electronic devices nearby in acoustic messages. It may be possible to transmit the 16-byte IPv6 address using sixteen sine signals simultaneously. The sine frequencies must be separated enough in frequency (Hz) to allow the second device to keep them apart to receive the data from each of them correctly at the same time. The detection period of the IPv6 address using sixteen sine frequencies simultaneously as discussed above is the time period of the largest number transmitted. In this example, the detection period is the transmission time of the largest number N*(255+1)=N*256 samples. At 48 kHz, the maximum detection period will be approximately N*5.4 milliseconds.

In another embodiment of the invention, the first device will use different amplitude levels to shorten the detection period as illustrated in FIG. 4. When transmitting an IP address (e.g. 192.168.86.2), the first device will vary the amplitude to encode the IP address. It will increase the amplitude level until the amplitude of the sine signal is within the acceptable range and transmit the sine signal for a time period corresponding to the first byte of the IP address (i.e. N*(192+1) samples) before reducing the amplitude below the acceptable range or even all the way down to a zero amplitude if preferred and keep it there for a time period corresponding to the second byte of the IP address (i.e. N*(168+1) samples). The amplitude will be increased again until it is within the acceptable range and kept there for a time period corresponding to the third byte of the IP address (i.e. N*(86+1) samples) before reducing the amplitude below the acceptable range and keep it there for a time period corresponding to the fourth byte of the IP address (i.e. N*(2+1) samples). By using the length of the time period in-between time periods where the amplitude is below the acceptable range can reduce the overall detection time.

The first device will transmit the acoustic message within a frequency range compatible to a pre-configured sampling rate suitable for the output of the audio system of the first device as well as the input of the second device receiving and sampling the received signals. Some platforms only support a 48 KHz sampling rate for input and output, while others support higher sampling rates such as 96 kHz, 192 kHz, 384 kHz, etc. If the time-modulation is using a specific number of samples as the transmit unit and not absolute time in microseconds, the first and second device must agree on the both the frequencies to use and the sampling rate. Based on the frequencies used by the first and second device, in order to limit the power consumption of both or one of the devices, the first and second device should select the lowest sampling rate from a set of pre-configured sampling rates that will still allow use of the transmit frequencies according to the Nyquist sampling theorem, e.g. a frequency of 25 kHz requires the lowest sampling rate above 2*25 kHz=50 kHz. A sampling rate above 50 kHz will be necessary if the acoustic message is sent using time-modulation with a sine frequency of 25 kHz. If the acoustic message is sent from the first device with time-modulation with a frequency of 22.5 kHz, the sampling rate needs to be above 2*22.5 kHz=45 kHz. The first and second devices may need to be pre-configured with the time-modulated frequencies that should be used to transmit and receive the acoustic messages properly.

In some embodiments, the second device may include at least one acoustic transmitter capable of transmitting an acoustic message back to the first device using time-modulation with the same or a separate set of frequencies. The message may be interpreted as an acknowledgement of receiving the acoustic message transmitted by the first device. It may even include a hash or CRC of the acoustic message transmitted by the first device. If the acoustic message from the first device includes a timestamp or a monotonically increasing sequence number, the first device may filter out acknowledgements from the second device that are too old or outside the acceptable window of timestamps or sequence numbers.

In some embodiments, the second device may send a time-modulated acoustic message asking the first device to increase the transmit unit if the time-modulated message is not identifiable with the current signal-to-noise ratio. This may be necessary in situations with interference from other sources or echo effects from the time-modulated signals themselves.

There are other modulation techniques that are more efficient and can increase the bit rate of the acoustic communication. However, time-modulation is a simple technique that can be implemented in small electronic devices without too much processing power. It is not ideal for transferring large amounts of data, but it is good enough for short messages (e.g. messages) between electronic devices.

The amplitude level of the acoustic messages should preferably be adjusted to the space where the acoustic message is being transmitted. This may be a configurable option based on the size of the space or the part of the space that may be used by recipients of the acoustic messages when the need it. It is also possible to use a calibration process where the first device transmits a continuous signal at a specific amplitude level and with a predefined frequency and the second device, which in this case is used for calibration, is moved to the far end of the space to provide feedback on the amplitude. The second device will accept a specific amplitude level by sending a message to the first device using a communication network. If the second device can reliably detect the signal with the current amplitude, the first device may reduce the amplitude and the experiment can be repeated. This iterative process of trying out a specific amplitude level can continue until the amplitude level is the minimum acceptable amplitude level for the second device at the far-end of the space. The calibration process could also be used to select the frequencies used by the first device to avoid impact from other sources or echo effects from large reflectors or surfaces.

Another challenge for the time-modulated scheme discussed here is the effect of echos from different surfaces may have on the transmit period and how large the transmit unit needs to be to identify the transmit period correctly. The transmit unit could be selected during a calibration process when installing the first device. During this calibration process the first device could send a known time-modulated sequence of numbers using a specific transmit unit. The transmit unit could be increased by changing the configuration or setup of the first device automatically or manually by the IT administrator. The transmit unit should be increased from N=1 up to a value of N that enables the second device to robustly identify the sequence of numbers. The sequence of numbers should include neighboring numbers etc to make it easier for the second device to decide if the transmit unit is acceptable. Since the calibration process should be done after the first device is installed, the selection of the transmit unit will take the actual space where the first device will operate into account when deciding the transmit unit. If the first device is moved somewhere else (e.g mobile device) the calibration process may have to be repeated. The calibration process may also be repeated if at a later stage a second device detects (e.g. illegal values in the acoustic message) that it does not successfully decode the acoustic message from the first device.

Each time-modulated time period needs to have both a beginning and an end. For amplitude-based acoustic signals, as illustrated in FIG. 5, the alternative is a steep increase or decrease in the amplitude to mark the beginning and the end of the time-modulated time period respectively. The amplitude increase (i.e. beginning of time period) may be a ramp up of the signal from a noticeable lower amplitude level (e.g. 0 amplitude) until the selected amplitude level is reached. The amplitude decrease (i.e. end of time period) may be a ramp down of the signal to a noticeable lower amplitude level (e.g. 0 amplitude) until the lower amplitude level is reached. The ramp up and ramp down periods should be a short and steep as possible to avoid audible effects from the acoustic output device (e.g. pop noise). The lower amplitude level and the ramp up/down period could be included in the calibration process to select the transmit unit as discussed earlier to make sure the beginning and the end of these time periods are part of the transmit unit selection. Using a higher amplitude in between time-modulated time periods is also possible but it would increase the power consumption and make it more difficult to separate time-modulated signals from the direct path between the first and second device from echos bouncing off other objects and surfaces in the space. There are other ways of identifying the beginning and end of the time-modulated time period such as pulse at a separate but different frequency, signal phase shift, but changing amplitude is by far the simplest one.

The amplitude level may in some cases be important. In FIG. 6 it is illustrated that it can change a few dB if people are moving around in the space. It means that the difference between the acceptable amplitude level of the time-modulated time period and the lower level between these periods need to be higher than changes due to people moving around in the space. It is also possible to constantly send an additional amplitude detection sine with a frequency close to the frequency used for time-modulation. This amplitude detection sine will be transmitted with the same amplitude as the time-modulated one. If the amplitude of both sine signals is changed comparably up or down at the same time, it is caused by walls being removed or people or objects moving around in the space. If only the time-modulated frequency is changing its amplitude, it is by done by the first device as part of the time-modulation scheme to begin or end a time period. If the first device is using time-modulation with multiple frequencies to transmit the acoustic message at a higher bandwidth, the first device could in many situations compare the amplitude changes in all the sine signals to find out if the amplitude change was random or deliberately done by the time-modulating first device. Still, a separate amplitude control signal could be easier even if the first device is transmitting on multiple frequencies.

In one embodiment of the present invention, the second device may not be capable of receiving acoustic messages in the ultrasonic range. If the second device could receive acoustic messages in the audible range, the first device could use a lower sampling rate which would, due to aliasing, mirror the transmitted frequencies around the sampling rate of the second device. If the time-modulated time periods are based on actual time or the transmit unit at the sampling rate used by the first device is known, the second device could calculate the absolute time of the transmit unit. With this information, the second device could extract the acoustic message by receiving and processing the aliased frequencies transmitted by the first device. If this aliasing causes more issue with correct interpretation of the time-modulated time periods, a forward error correction scheme could be used when creating the acoustic message.

The first device might be a wifi hotspot, a video conferencing system and controllable light source, a speaker system, etc. Any electronic device that provides information to other devices enabling them to connect to a specific service, electronic device or network.

If the network address extracted from the acoustic message by the second device is not the correct address or that the second device cannot connect to the device due to network issues, the second device can try all the other network addresses in the acoustic message one by one until it finds one that works. If the acoustic message did not include any optional network addresses, the second device could send an acoustic message to the first device. The second device should listen for other acoustic sources in the environment and if necessary due to interference issues either delay the transmission or possibly change the frequency or a set of frequencies before transmitting the acoustic message to the first device or the device it should communicate with. If the acoustic message includes an error message, it should indicate what the problem is, and in that case, the second device could request an alternative network address from the first device transmitted in a new acoustic message from the first device. If none of the alternative network address is working, the second device should send an acoustic message with indicating that the communication channel is broken.

If the either the first or second device does not include any network interface connected to a logically shared communication network or none of the advertised communication channels are working for an unknown reason, the only viable option for the devices is to communicate using acoustic messaging based on some sort of modulation technique which may be time-modulation.

In one embodiment of the present invention, the first device is a light-fixture that can be controlled by an app in a Smartphone. Once the smartphone app receives the acoustic message with the information about the light fixture, the app can connect to the controlling unit of the light fixture and based on the ID of the light fixtures embedded in the acoustic message, it can connect to the controlling unit and take over control of the specific light fixture. If there are multiple light-fixtures, the smartphone app may use positioning as described in US2017/0083285 or WO2020/046137 to single out the light fixture to control. This could be done even if there are multiple light fixtures in the same space if the light fixtures are transmitting their acoustic message one after the other. The smartphone app can align the line through at least two of its acoustic receivers perpendicular to the direction of the light fixtures that should be controlled. Once the second device receives the acoustic message that belong to the first device it is pointing the smartphone too, it can use the information in the acoustic message to connect to the controlling unit and assume control over the light fixture.

In another embodiment of the present invention, the first device is a monitoring device that keeps track of whether the second device is still close by. The first device can monitor more than one second device if these devices can be identified by their unique time-modulated acoustic messages or coded acoustic messages. These second devices could use either time-division multiplexing or frequency multiplexing to prevent that their acoustic messages interfere with each other. If any of the acoustic messages that the first device is monitoring disappears, it means that the corresponding second device has stop working or been removed from the space or room where the first device is. The first device could be a security device that could potentially sound an alarm or send an alarm message to indicate that a particular device is no longer working properly or has been removed or even stolen.

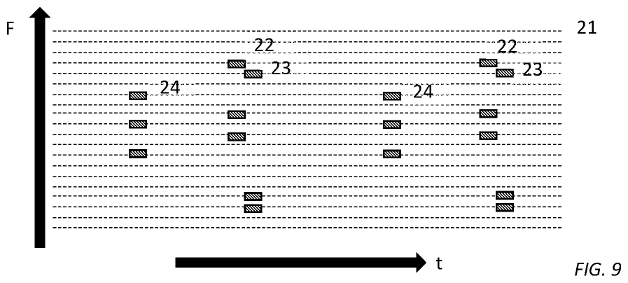

In FIGS. 8 and 9 the use of several frequencies is illustrated. In FIG. 8 the signal 22 including three different frequency bands is transmitted. The receiver is able to detect the signals and their corresponding signal durations for analyzing and detecting the transmitted code. In FIG. 9 there are three different signals, each including three different frequencies. As stated above a case with 20 different sine frequencies available and first device using 3 different sine pulses in each message, the number of unique sine pulse triplets is 1140. This will improve the ability of the receiver to distinguish the different signal sources.

To summarize the present invention relates to a method and system for establishing communication between two electronic devices through a wireless communication system where the each of the devices also includes an acoustic transducer. The method includes the steps of:
transmitting from a first of said devices a first, acoustic signal in a predetermined frequency range for at least one predetermined time period where the acoustic signal includes code being recognizable for the second device, and where the code includes information for enabling connections between the devices,
receiving at a second of said devices the acoustic signal and analyzing said code, where the analysis includes recognizing the at least one predetermined time period(s),
based on said code transmitting a second signal, from the second device establishing communication with the first device.

The transmitted acoustic signal may be constituted by a plurality of acoustic frequencies where the code includes information in at least two of the acoustic frequencies. Alternatively, the code is included in a sequence of acoustic signals within said time period.

The second signal may be an acoustic or electromagnetic communication system, and the communication when established may be in the electromagnetic range where the transmitted code includes an IP address or similar for connecting to the first device ..

The transmission of the first acoustic signal may be initiated by a detected movement in the vicinity of the first device, e.g. using a movement sensor in one of the devices or an external sensor. The transmission of the first acoustic signal is initiated at the receipt of a request signal from the second device.

The present invention also relates to a communication system including at least two electronic devices. As discussed above the first device is configured to transmit a first acoustic signal in a predetermined frequency range for at least one predetermined time period, the acoustic signal including a recognizable code, the code including connection information enabling communication between the devices. A second device is configured to receive and analyse the transmitted signal, where the analysis includes detection of the at least one predetermined time period(s) and at the detection of the code transmitting a second signal for establishing communication with the first device.

As mentioned above the transmitted acoustic signal is constituted by a plurality of acoustic frequencies, the code including information in at least two of the acoustic frequencies. As an alternative the the code is included in a sequence of acoustic signals within said time period.

The devices in the system may include both acoustic transmitters and receivers thus enabling communication through acoustic signals withing a specific frequency range, preferably outside the audible range, preferably in the ultrasonic range, and thus the second signal may also be an acoustic signal.

The second signal is an electromagnetic communication signal, especially when the established communication is in the electromagnetic range. The transmitted code includes an IP address or similar enabling the second device to connecting to the first device through a IP network.

1-16. (canceled)

17. A method for establishing communication between two electronic devices, the method comprising:
transmitting from a first of the devices a first, acoustic signal in a predetermined frequency range for at least one predetermined time period, the acoustic signal comprising a recognizable code, the code comprising connecting information defined by the transmit time periods of the transmitted signal;
receiving at a second of the devices the acoustic signal and analyzing the code, where the analysis comprises recognizing the at least one of the transmitted at least one predetermined time period(s); and
based on the code, transmitting a second signal for establishing communication with the first device.

18. The method according to claim 17, wherein the transmitted acoustic signal is constituted by a plurality of acoustic frequencies, the code comprising information in at least two of the acoustic frequencies.

19. The method according to claim 17, wherein the code is included in a sequence of acoustic signals within the time period.

20. The method according to claim 17, wherein the second signal is an acoustic signal.

21. The method according to claim 17, wherein the second signal is an electromagnetic communication signal, the established communication being in the electromagnetic range.

22. The method according to claim 21, wherein the transmitted code comprises an IP address or similar for connecting to the first device.

23. The method according to claim 17, wherein the transmission of the first acoustic signal is initiated by a detected movement in the vicinity of the first device.

24. The method according to claim 17, wherein the transmission of the first acoustic signal is initiated at the receipt of a request signal from the second device.

25. A communication system comprising at least two electronic devices, wherein the first device is configured to transmit a first acoustic signal in a predetermined frequency range for at least one predetermined time period, the acoustic signal comprising a recognizable code, the code comprising connecting information defined by the transmit time periods of the signal, and a second device being configured to receive and analyze the transmitted signal, the analysis comprising detection of the at least one predetermined transmit time period(s) and at the detection of the code transmitting a second signal for establishing communication with the first device.

26. The communication system according to claim 25, wherein the transmitted acoustic signal is constituted by a plurality of acoustic frequencies, the code comprising information in at least two of the acoustic frequencies.

27. The communication system according to claim 25, wherein the code is included in a sequence of acoustic signals within the time period.

28. The communication system according to claim 25, wherein the second signal is an acoustic signal.

29. The communication system according to claim 25, wherein the second signal is an electromagnetic communication signal, the established communication being in the electromagnetic range.

30. The communication system according to claim 29, wherein the transmitted code comprises an IP address or similar for connecting to the first device.

31. The communication system according to claim 25, wherein the transmission of the first acoustic signal is initiated by a detected movement in the vicinity of the first device.

32. The communication system according to claim 25, wherein the transmission of the first acoustic signal is initiated at the receipt of a request signal from the second device.
